(19) United States
(12) Patent Application Publication
(10) Pub. No.: US 2011/0148606 A1
(43) Pub. Date: Jun. 23, 2011

(54) ALARM ORGANIZER SYSTEMS

(76) Inventors: Trina Glee, New York, NY (US); Charles Glee, New York, NY (US)

(21) Appl. No.: 12/972,185

(22) Filed: Dec. 17, 2010

Related U.S. Application Data
(60) Provisional application No. 61/287,331, filed on Dec. 17, 2009.

(51) Int. Cl. G08B 1/00

(52) U.S. Cl. 340/309.7

(57) ABSTRACT

A programmable alarm organizing device comprising: a settable alarm capable of sounding at least one audible tone over speakers; a timing mechanism; a recording mechanism. The settable alarm is able to be programmed at one interval to actuate audible tones at multiple times during a period such as a day, week, year(s). The timing mechanism activates the settable alarm and displays a visual readout of a time. The recording mechanism in combination with the touch screen calendar is used to input information to activate the settable alarm.

### CROSS-REFERENCE TO RELATED APPLICATION

The present application is related to and claims priority from prior provisional application Ser. No. 61/287,331, filed Dec. 17, 2009 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of alarms and more specifically relates to alarm organizer systems.

2. Description of the Related Art

Many individuals use alarm clocks to wake them at designated times to prevent missing important events. Alarms are typically ‘set’ to make a loud ringing, buzzing noise or activate a radio or other musical sound at a specific time. The primary use of alarm clocks is to awaken people from their sleep in order to start their days in the mornings, but can also be used for short naps; they are sometimes used for other reminders as well. To stop the sound, a button switch, or handle on the clock needs to be pressed by the awakened individual, and some alarm clocks stop automatically after a few minutes if left unattended.

Traditional mechanical alarm clocks have one or two bells that ring, but digital alarm clocks can make other noises such as those disclosed above. Simple battery-powered alarm clocks make a loud buzzing sound, or other similar noise to wake a sleeper, while modern novelty alarm clocks can sing, speak, or even laugh. Some alarm clocks have radios that can be set to start playing at specified times, and are known as clock radios. A progressive alarm clock, still new in the market, can have different alarms for different times such as progressive alarms to gently wake the sleeping individual.

A significant number of individuals set an alarm clock before they go to bed to make sure they wake up in time in the morning. Typical digital alarm clocks provide an alarming means consisting of a loud noise or music being activated, but do not include a verbal reminder of any upcoming events. A significant amount of consumers program reminders into a smart phone or other similar hand held devices, but they may not be designed specifically for waking purposes and so fall short in providing users with many convenient options/features such as volume control and high quality speakers for listening to music.

Various attempts have been made to solve the above-mentioned problems such as those found in U.S. Patent and Publication Nos. 2004/0192996; U.S. Pat. Nos. 5,511,046; 5,794,205; 4,368,988; 5,014,317; and 6,998,961. This prior art is representative of alarms. None of the above inventions and patents, taken either singly or in combination, is seen to describe the invention as claimed.

Ideally, alarm organizer systems should operate reliably and be manufactured at a modest expense. Thus, a need exists for a reliable alarm organizer system to provide a waking and schedule reminding means and to avoid the above-mentioned problems.

### BRIEF SUMMARY OF THE INVENTION

In view of the foregoing disadvantages inherent in the known alarm art, the present invention provides novel alarm organizer systems. The general purpose of the present invention, which will be described subsequently in greater detail is to provide waking and schedule reminding means.

A programmable alarm organizing device is disclosed herein comprising: a settable alarm capable of sounding at least one audible tone over at least one speaker; a timing mechanism; a recording mechanism (the recording mechanism is controlled via push button controls consisting of PLAY, STOP, PAUSE, FORWARD, BACKWARD, DELETE, and SAVE); wherein the settable alarm is able to be programmed at one interval to actuate audible tone(s) at multiple times during a period. The timing mechanism activates the settable alarm and displays a visual readout of a time optionally the time may be displayed on a touch screen calendar. The recording mechanism in combination with the touch screen calendar is used by at least one user to input information to activate the settable alarm. In certain embodiments the programmable alarm organizing device further comprises a station changer/selector.

The audible tone may comprise at least one oral itinerary reminder, at least one oral upcoming engagement reminder, and/or at least one oral upcoming deadline reminder. In certain embodiments the programmable alarm organizing device may further comprise an MP3 dock which is capable of playing at least one song over the speakers. The oral itinerary, upcoming engagement, and upcoming deadline reminder(s) may be stored in a memory for up to at least one year. The oral itinerary reminder is schedulable via said touch screen calendar.

The touch screen calendar is preferably located on an upper surface of the programmable alarm organizing device. The audible tone over the speakers is volume controllable via a touch pad or buttons. The visual readout may be in analog and/or digital format. The present invention may be powered via AC power and/or optionally via DC power.

A method of use for the present invention, programmable alarm organizing device is also disclosed herein; the method of using a programmable alarm organizing device preferably comprising the steps of: recording at least one verbal tone via a recording mechanism; and programming the programmable alarm organizing device via a touch screen calendar to audibilize at least one verbal tone at at least one pre-determined interval as an alarm-reminder of an itinerary, engagement or deadline reminder. The method optionally further comprising the step of scheduling the itinerary, engagement or deadline reminders for a period of up to at least one year.

The present invention holds significant improvements and serves as an alarm organizer system(s). For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, alarm organizer systems, constructed and operative according to the teachings of the present invention.

FIG. 1 shows a perspective view illustrating an alarm organizer system in use according to an embodiment of the present invention.

FIG. 2 is a perspective view illustrating various options available on the alarm organizer system according to embodiments of the present invention of FIG. 1.

FIG. 3 is a perspective view illustrating other various options available on the alarm organizer system according to embodiments of the present invention of FIG. 1.

FIG. 4 is a perspective view illustrating yet other various options available on the alarm organizer system according to an embodiment of the present invention of FIG. 1.

FIG. 5 is a perspective view illustrating the alarm organizer system in use according to embodiments of the present invention of FIGS. 1-4.

FIG. 6 is a flowchart illustrating a method of use for the alarm organizer system(s) according to an embodiment of the present invention of FIGS. 1-5.

The various embodiments of the present invention will hereinafter be described in conjunction with the appended drawings, wherein like designations denote like elements.

### DETAILED DESCRIPTION

As discussed above, embodiments of the present invention relate to an alarm device and more particularly to an alarm organizer system as used to improve the efficiency and effectiveness of waking and schedule reminding means for individuals.

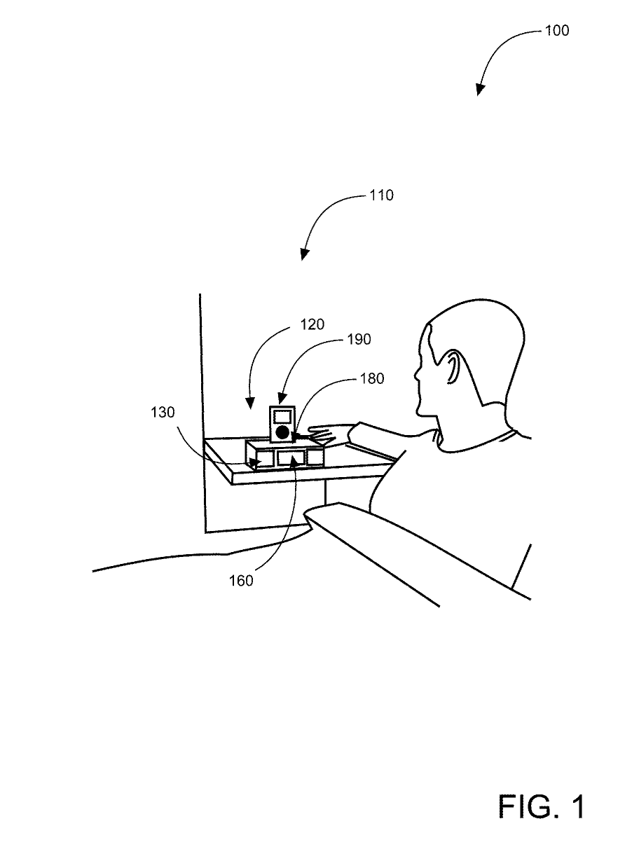

Referring to the drawings by numerals of reference there is shown in FIG. 1, a perspective view illustrating alarm organizer system 100 in use according to an embodiment of the present invention.

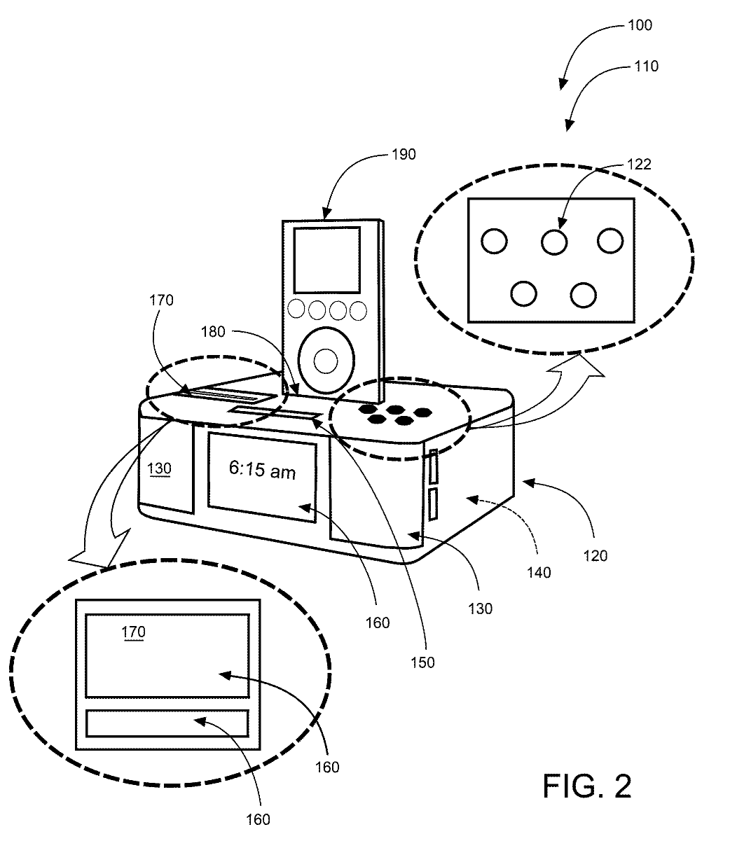

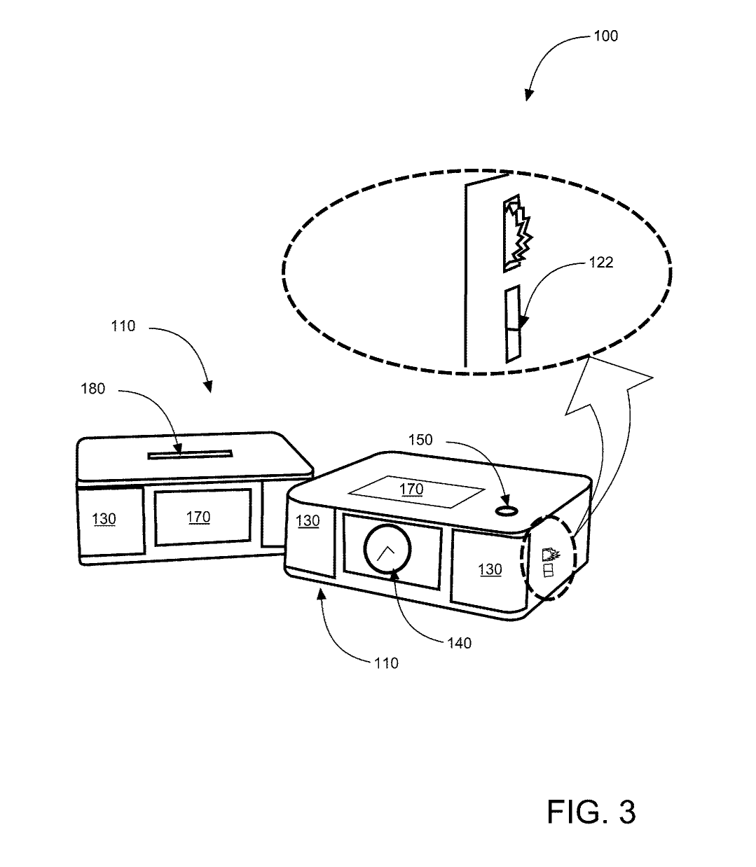

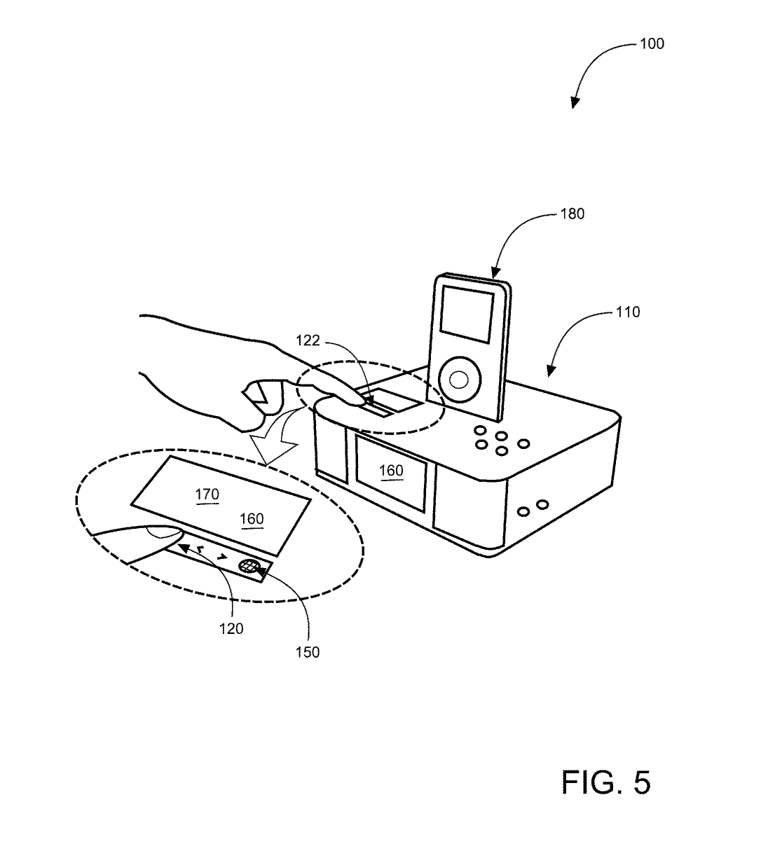

The embodiments shown generally in FIGS. 1-5 illustrate programmable alarm organizing device 110 preferably comprising: a settable alarm 120 capable of being set and activating/sounding at least one audible tone over at least one speaker 130; a timing mechanism 140; and a recording mechanism 150. Settable alarm 120 is able to be programmed at one interval to actuate at least one audible tone at multiple times during a period. For example user may program the device, as illustrated in FIGS. 1 and 5 with several appointments before going to bed in order to remind the user the next morning upon wake up (or just subsequent to wake up) of the upcoming day's events, as scheduled Timing mechanism 140 activates settable alarm 120 and may preferably display at least one visual readout 160 of a time (or other) on a front surface of programmable alarm organizing device 110 (as shown) and/or optionally on touch screen calendar 170 (not shown). Recording mechanism 150 in combination with touch screen calendar 170 may be used to input information/set times to activate settable alarm 120. Touch screen calendar 170 is preferably located on an upper surface of programmable alarm organizing device 110, as shown in FIGS. 2-5. In other embodiments touch screen calendar 170 may be located in other locations on programmable alarm organizing device 110, as alluded to in FIG. 3. Additionally, alarm control buttons 122 may enable the user to set the various alarm times.

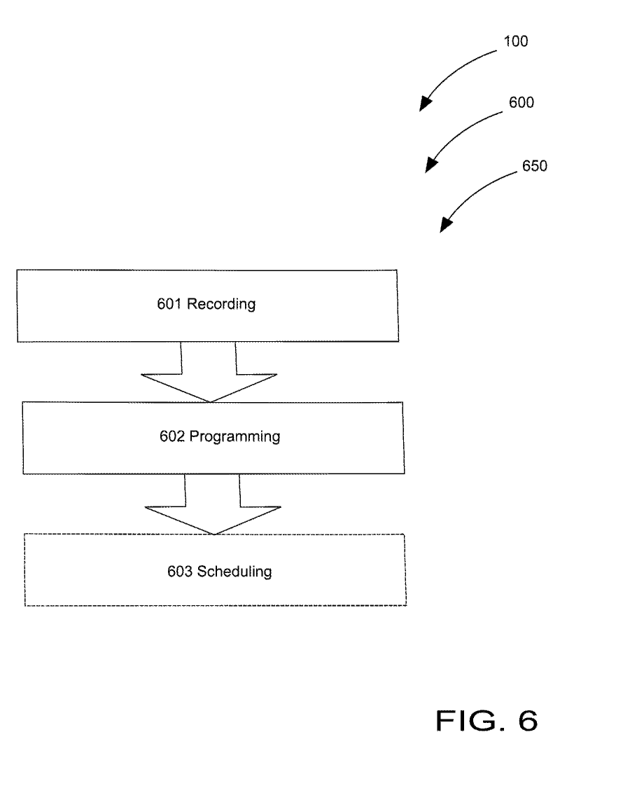

Within the particular embodiment shown, programmable alarm organizing device 110 can be programmed (pre-programmed) to alert the user of his/her appointments for the upcoming day(s). In this way this embodiment of the present invention is ideal for the busy individual who could use an audible reminder of upcoming deadlines or activities. Alarm organizing device 110 may comprise a clock (at least herein embodying timing mechanism 140), a radio, and touch screen calendar 170 that allows users to program in important dates and times. FIG. 3 shows an example of an analog version and a digital version of clock(s) as operated by timing mechanism 140 to output visual readout 160. There may also be a recording feature (at least herein embodying recording mechanism 150), where users can verbally and text input their itinerary for the next day's schedule and set corresponding alarms (settable alarm 120). At the set time, settable alarm 120 will sound preferably followed by the voice recording reminding the user of their upcoming engagement(s). Use of recording mechanism 150 is shown and discussed in greater detail in FIGS. 5 and 6.

As discussed above, settable alarm 120 will sound preferably followed by the output of a voice recording reminding the user of their upcoming events/schedule. Typically the alarm is sounded and a reasonable amount of time for the user is provided to awaken before voice recordings are relayed. In the embodiment shown, the oral itinerary reminder(s) may be stored in a memory for up to at least one year (optionally more than, less than or equal to). The oral upcoming engagement reminder(s) may also be stored in a memory for up to at least one year (optionally more than, less than or equal to). Further, the oral upcoming deadline reminder(s) may be stored in a memory for up to at least one year (optionally more than, less than or equal to). These events are preferably stored on/in touch screen calendar 170. Those with ordinary skill in the art will now appreciate that upon reading this specification and by their understanding the art of memory as described herein, methods of memory storage will be understood by those knowledgeable in such art. The oral itinerary reminder(s) is/are schedulable via touch screen calendar 170. Touch screen calendar 170 comprises an electronic visual display that can detect the presence and location of a touch within the display area, as shown in FIG. 5. Touch screen calendar 170 may be activated with a finger, or a stylus.

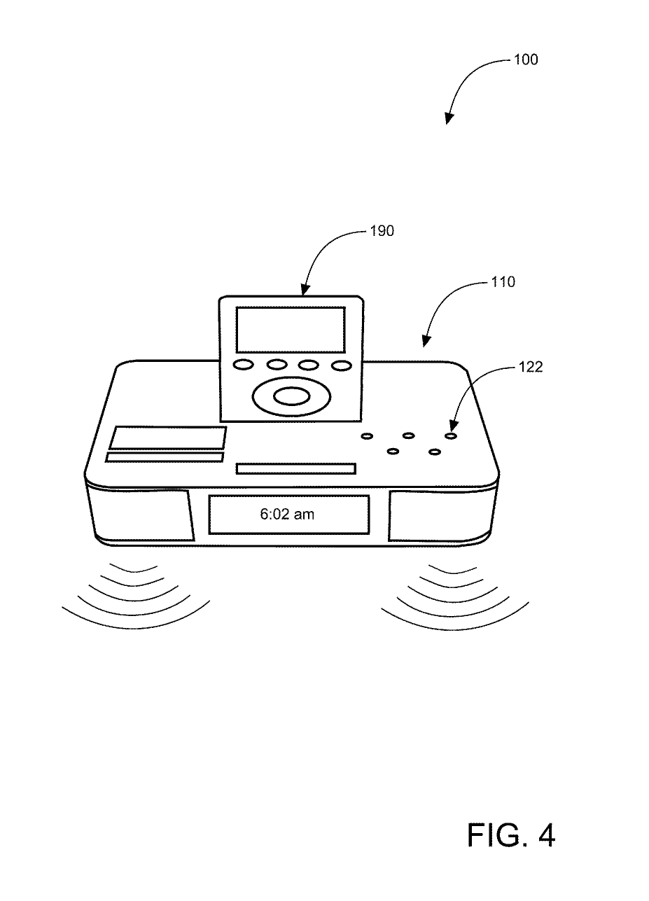

When the time is set via timing mechanism 140, the user-operator may have the option to set recording mechanism 150 (shown in FIGS. 1 and 5) so programmable alarm organizing device 110 can record his/her appointments verbally for the upcoming day. Recording mechanism 150 preferably comprises an acoustic-to-electric transducer or sensor that converts sound into an electrical signal. When settable alarm 120 is activated as pre-programmed, timing mechanism 140 may automatically retrieve all the appointments the individual has recorded and saved for that day. Sounds to awaken individual as actuated by settable alarm 120 may include music, bells, beeping, radio, or songs stored on the users docked MP3 player 190. The at least one audible tone, as described, may comprise at least one oral itinerary reminder and/or at least one oral upcoming engagement reminder and/or oral upcoming deadline reminder. The audible tone as emitted over speaker(s) 130 is volume controllable, as shown in FIGS. 3 and 4. Upon reading this specification, it should be appreciated that, under appropriate circumstances, considering such issues as user preferences, design preference, structural requirements, marketing preferences, cost, available materials, technological advances, etc., other alarming sounds/noises and/or arrangements such as, for example, different tones, different sounds, different sound combinations and orders, combinations of audible and inaudible tones, with or without text, etc., may be sufficient.

Programmable alarm organizing device 110 of alarm organizer systems 100 may be programmed to allow users to record appointments for up to a year within certain embodiments.

After settable alarm 120 is sounded, programmable alarm organizing device 110 may then repeat the appointment recordings sequentially until the user turns it off. This allows the user to formulate an efficient plan for the upcoming day. In this way the present invention serves to provide both a waking and an information providing/reminding means in an efficient and effective manner. If the individual misses an appointment(s), they may have the option to retrieve the information to hear the recording again. Additionally the user may be able to skip through unimportant details or listen to the recordings out of sequence. Events may also be retrieved in order of relevance or implied significance as determined by the user-programmer. Even after the user turns off settable alarm 120, they still have the option to retrieve the stored appointment(s). Programmable alarm organizing device 110 may be programmed to automatically erase information stored at the end of each day or other such user-specified time period. Users may also have the option to delete appointments earlier if desired.

Referring now to FIG. 2, a perspective view illustrating various options available on alarm organizer system 100 according to embodiments of the present invention of FIG. 1. FIG. 2 shows a variation of programmable alarm organizing device 110, comprising the optional MP3 dock 180, touch screen calendar 170, and voice recorder buttons for activating recording mechanism 150, as also alluded to in FIG. 5. The top of programmable alarm organizing device 110 may include a digital touch screen calendar 170 to pre-program events and a voice recorder with push button controls such as play, stop, pause, forward, backward, delete, save, and any other controls deemed necessary. This embodiment of programmable alarm organizing device 110 may measure about 3″ in height X 5″ in length X 5″ in width, making it portable for use when travelling if desired. Upon reading this specification, it should be appreciated that, under appropriate circumstances, considering such issues as user preferences, design preference, structural requirements, marketing preferences, cost, available materials, technological advances, etc., other sizes, options and arrangements such as, for example, larger or smaller length, width and height, different button or dial arrangements, different options, etc., may be sufficient. Materials, colors and other specifications may also vary depending upon user preference.

Referring now to FIG. 3, a perspective view illustrating other various options available on alarm organizer system 100 according to embodiments of the present invention of FIG. 1.

FIG. 3 specifically shows a magnified view of a volume control and radio dial and/or alarm control button(s) 122. As shown, the side of programmable alarm organizing device 110 may include at least one dial that changes the radio stations and a second dial to be used for volume control for increasing or decreasing the audible level of sounds emitting from speakers 130. Programmable alarm organizing device 110 may be powered via AC power and/or alternately powered via DC power (particularly useful for portability when travelling). The present invention may have at least one visual readout 160 that is analog and/or digital, as shown.

In certain embodiments the programmable alarm organizing device 110 further comprises an MP3 dock 180 (shown in left embodiment) capable of playing at least one song over speaker(s) 130. The optional MP3 dock 180 gives users the option of listening to music through docked MP3 player 190 as they complete work around the home or office, as shown in FIGS. 1-3 and 5. College students, professionals and busy parents are among the many users that may benefit from using this novel device.

Referring now to FIGS. 4 and 5, perspective views illustrating yet other various options available on alarm organizer system 100 for/in use according to embodiments of the present invention of FIGS. 1-5. FIG. 4 illustrates programmable alarm organizing device 110 emitting audible sound waves and FIG. 5 alluding to a user programming and voice recording on programmable alarm organizing device 110. Recording mechanism 150 is preferably controlled via push button controls consisting of PLAY, STOP, PAUSE, FORWARD, BACKWARD, DELETE, and SAVE. In other embodiments other options may be made available such as Fast-Forward, Fast-Rewind, text inputting buttons and others. Programmable alarm organizing device 110 may further comprise a station changer that may comprise a button. Recording mechanism 150 may comprise a microphone, as shown.

The outer housing of programmable alarm organizing device 110 may have a wood grain finish or other design(s) that suit user preferences. The front face may display the time through an analog or digital clock and have two, high quality surround sound speakers 130 embedded into it. In other embodiments sound speakers 130 may be detachable.

Alarm organizer system 100 may be sold as kit 440 comprising the following parts: at least one programmable alarm organizing device 110; at least one (dockable)/docked MP3 player 190; speakers 130 (optionally detachable); and at least one set of user instructions (not shown). Alarm organizer system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

Referring now to FIG. 6 showing a flowchart 650 illustrating a method of use 600 for the alarm organizer system(s) 100 according to an embodiment of the present invention of FIGS. 1-5.

A method of use 600 for programmable alarm organizing device 110 of alarm organizer systems 100 may comprise the steps of: step 601 recording at least one verbal tone via recording mechanism 150; and step two 602 programming programmable alarm organizing device 110 via touch screen calendar 170 (or optionally using alarm control buttons 122) to activate speakers 130 to audibilize at least one verbal tone at at least one pre-determined interval as an alarm-reminder of an itinerary, engagement or deadline reminder. The method of use may optionally further comprise the step three 603 of scheduling the itinerary, engagement or deadline reminders for a period of up to at least one year. It should be appreciated that daily (or portions of the day—seconds, minutes, hours, AM, PM), weekly, monthly, and yearly schedules may be made. In certain embodiments the scheduling may comprise scheduling over a period of more than a year.

It should be noted that step 603 is an optional step and may not be implemented in all cases. Optional steps of method 600 are illustrated using dotted lines in FIG. 6 so as to distinguish them from the other steps of method 600.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A programmable alarm organizing device comprising:
a settable alarm capable of activating at least one speaker to sound at least one audible tone thereover as a waking alarm;
a timing mechanism;
a recording mechanism including a transducer;
wherein said settable alarm is able to be programmed at one interval to actuate said at least one audible tone at multiple times during a period;
wherein said timing mechanism activates said settable alarm and displays a visual readout of a time on a front face of said programmable alarm organizing device; and
wherein said recording mechanism in combination with said touch screen calendar is used to input information to activate said settable alarm.

2. The programmable alarm organizing device of claim 1 wherein said at least one audible tone comprises at least one oral itinerary reminder subsequent to said waking alarm.

3. The programmable alarm organizing device of claim 1 wherein said at least one audible tone comprises at least one oral upcoming engagement reminder subsequent to said waking alarm.

4. The programmable alarm organizing device of claim 1 wherein said at least one audible tone comprises at least one oral upcoming deadline reminder subsequent to said waking alarm.

5. The programmable alarm organizing device of claim 1 further comprising an MP3 dock.

6. The programmable alarm organizing device of claim 5 wherein said MP3 dock is capable of playing at least one song over said at least one speaker.

7. The programmable alarm organizing device of claim 1 wherein said touch screen calendar is located on an upper surface of said programmable alarm organizing device.

8. The programmable alarm organizing device of claim 2 wherein said oral itinerary reminder(s) may be stored in a memory for up to at least one year.

9. The programmable alarm organizing device of claim 3 wherein said oral upcoming engagement reminder(s) may be stored in a memory for up to at least one year.

10. The programmable alarm organizing device of claim 4 wherein said oral upcoming deadline reminder(s) may be stored in a memory for up to at least one year.

11. The programmable alarm organizing device of claim 2 wherein said oral itinerary reminder is schedulable via said touch screen calendar.

12. The programmable alarm organizing device of claim 1 wherein said programmable alarm organizing device is powered via AC power.

13. The programmable alarm organizing device of claim 1 wherein said programmable alarm organizing device is powered via DC power.

14. The programmable alarm organizing device of claim 1 wherein said audible tone over said at least one speaker is volume controllable.

15. The programmable alarm organizing device of claim 1 wherein said visual readout is analog.

16. The programmable alarm organizing device of claim 1 wherein said visual readout is digital.

17. The programmable alarm organizing device of claim 1 wherein said recording mechanism is controlled via push button controls consisting of PLAY, STOP, PAUSE, FORWARD, BACKWARD, DELETE, and SAVE.

18. The programmable alarm organizing device of claim 1 further comprising a radio station changer.

19. A method of using a programmable alarm organizing device comprising the steps of:
recording at least one verbal tone via a recording mechanism; and
programming said programmable alarm organizing device via a touch screen calendar to activate speakers to audibilize said verbal tone at at least one pre-determined interval as an alarm-reminder of an itinerary, engagement or deadline reminder.

20. The method of using the programmable alarm organizing device of claim 19 further comprising the step of scheduling said itinerary, engagement or deadline reminders for a period of up to at least one year.
